(19) United States
(12) Patent Application Publication
(10) Pub. No.: US 2011/0088731 A1
(43) Pub. Date: Apr. 21, 2011

(54) SEMICONDUCTOR SUBSTRATE CLEANING METHOD USING BUBBLE/CHEMICAL MIXED CLEANING LIQUID

(75) Inventors: Hiroshi TOMITA, Yokohama-shi (JP); Hiroyasu Iimori, Yokohama-shi (JP); Hiroaki Yamada, Yokkaichi-shi (JP); Minako Inukai, Yokohama-shi (JP)

(73) Assignee: Kabushiki kaisha Toshiba, Tokyo (JP)

(21) Appl. No.: 12/978,933

(22) Filed: Dec. 27, 2010

Related U.S. Application Data
(62) Division of application No. 12/129,074, filed on May 29, 2008.

(30) Foreign Application Priority Data
May 29, 2007 (JP) 2007-142199

(51) Int. Cl. B08B 3/00; B08B 3/02

(52) U.S. Cl. 134/36

(57) ABSTRACT

A method has been disclosed which cleans a semiconductor substrate using a cleaning liquid produced by mixing bubbles of a gas into an acid solution in which the gas has been dissolved to the saturated concentration and which brings the zeta potentials of the semiconductor substrate and adsorbed particles into the negative region by the introduction of an interfacial active agent. Alternatively, a semiconductor substrate is cleaned using a cleaning liquid produced by mixing bubbles of a gas into an alkaline solution in which the gas has been dissolved to the saturated concentration and whose pH is 9 or more.

### CROSS-REFERENCE TO RELATED APPLICATIONS

This application is based upon and claims the benefit of priority from prior Japanese Patent Application No. 2007-142199, filed May 29, 2007, the entire contents of which are incorporated herein by reference.

### BACKGROUND OF THE INVENTION

1. Field of the Invention

This invention relates to a cleaning process in the semiconductor device manufacturing steps, and more particularly to a semiconductor substrate cleaning method using chemical (bubble/chemical mixed cleaning liquid) including bubbles of a nanometer or micrometer size.

2. Description of the Related Art

In recent years, a semiconductor device where MOSFETs with a gate length of 65 nm have been integrated has been developed and commercialized. In the case of the next-generation semiconductor devices whose patterns have been miniaturized further, those whose gate length is 50 nm or less have been developed.

To manufacture semiconductor devices of the 65-nm generation in a high yield, an advanced cleaning process is needed. Commonly-used physical cleaning methods include cleaning using ultrasonic waves (referred to as a MHz cleaning method) and cleaning using two-fluid jets (referred to as a two-fluid jet cleaning method). These cleaning methods are effective in removing particles generated during manufacturing semiconductor devices and adsorbed to the wafer and have been heavily used in the leading-edge device manufacturing processes.

However, in the MHz and two-fluid jet cleaning methods, there is a strong correlation between the particle removal efficiency and the incidence of defects in the device pattern. That is, with higher power, the particle removal efficiency increases, but the possibility that the pattern will be damaged becomes stronger. In contrast, under a low-power condition that prevents the pattern from being damaged, the particle removal efficiency decreases and the fabrication yield cannot be increased as much as expected.

Furthermore, in the semiconductor devices of the 50-nm generation and afterward, since the pattern size is smaller than the size of particles to be removed, cleaning becomes more difficult than now; therefore, it is expected that manufacturing devices in a high yield will become very difficult.

This situation has required a new cleaning method in place of the MHz cleaning method or two-fluid jet cleaning method commonly used in the semiconductor manufacturing processes.

In the case of microparticles of 0.1 microns (100 nm) or less in size, the smaller the particle size, the higher the surface energy. When particles are adsorbed to the pattern surface, they do not separate easily from the adsorbing surface due to the influence of molecular attraction. To cope with this phenomenon, a cleaning method that does not use the aforementioned physical force is needed.

For example, as a method of removing particles adsorbed to the pattern surface by lifting them off together with the film at the surface adsorbing the particles, an alkali cleaning method, such as RCA cleaning or SC-1 cleaning, an improved version of RCA cleaning, has been proposed (e.g., refer to Jpn. Pat. Appln. KOKAI Publication No. 2006-80501). In the alkali cleaning method, cleaning is generally done using a mixed liquid of ammonia water and hydrogen peroxide solution.

However, depending on the underlaying material that has adsorbed particles, the alkali cleaning method cannot be applied. The reason is that, since through oxides and the like used in the ion implanting process for manufacturing transistors are thin, they are etched by the alkali cleaning liquid.

As described above, since the cleaning method using chemicals has some manufacturing steps unsuitable for use, a new cleaning process has been required which is capable of dealing with such next-generation microfabrication processes, as well as suppress the etching of the underlaying material and prevent defects in the pattern from occurring.

On the other hand, in the field excluding semiconductors, a cleaning method has already been proposed which uses nano-bubbles and micro-bubbles generated by the application of ultrasonic waves or by electrolysis in ultrapure water, electrolyzed water, ion-exchanged water, or the like (e.g., refer to Jpn. Pat. Appln. KOKAI Publication No. 2004-121962).

In the technique disclosed in Jpn. Pat. Appln. KOKAI Publication No. 2004-121962, various kinds of objects, including nanotechnology-related apparatuses, industrial products, and clothes, have been cleaned in an ultrasonic-wave-applied environment or with nano-bubbles generated by electrolyzing water.

It is reported that cleaning can be performed using high functions, including the functions of adsorbing the dirt components in a liquid, of cleaning the object surface at high speed, and of sterilizing the object surface, with a low environmental burden without using soap or the like. It is also reported that not only polluted water including dirt components separated into water but also polluted water generated in a wide range of fields can be cleaned effectively by the function of adsorbing dirt components in a liquid. As for a living body, it is further reported that dirt adhering to the body surface can be removed by sterilization, air jet, or soap and various effects of finger pressure by air jet can be obtained. In addition, the generation of a local high-pressure field, the realization of electrostatic polarization, or the increase of the chemical reaction surface enables cleaning to be applied effectively even for chemical reactions.

Some problems with the aforementioned MHz cleaning method, two-fluid jet cleaning method, and alkali cleaning method are considered capable of being solved by applying the cleaning method using nano-bubbles or micro-bubbles to the semiconductor manufacturing processes. However, with a conventional in-liquid bubble generator, it is difficult to generate bubbles of several nanometers in size stably. The reason is that, in a bubble generating method using an already-proposed quartz bubbler, gas bubbles in the liquid decrease the surface energy and therefore grow very big due to bubble combination (coalition). Furthermore, when bubbles are generated in a liquid, since the bubbles continue growing very big until bubbles have desorbed from the bubble generating region due to buoyancy in the liquid, it is difficult to generate nano-sized bubbles.

Accordingly, an in-liquid bubble mixing apparatus capable of generating bubbles of several nanometers in size stably and mixing them into a cleaning liquid has been desired.

### BRIEF SUMMARY OF THE INVENTION

According to a first aspect of the invention, there is provided a semiconductor substrate cleaning method comprising: immersing a semiconductor substrate in an acid cleaning liquid in which a gas has been dissolved to a saturated concentration, the cleaning liquid including an interfacial active agent and the zeta potentials of the semiconductor substrate and adsorbed particles being negative; generating bubbles of the gas dissolved in the cleaning liquid; and cleaning the semiconductor substrate by applying the cleaning liquid including bubbles of the gas to the surface of the semiconductor substrate.

According to a second aspect of the invention, there is provided a semiconductor substrate cleaning method comprising: immersing a semiconductor substrate in an alkaline cleaning liquid in which a gas has been dissolved to a saturated concentration, the pH of the cleaning liquid being 9 or more; generating bubbles of the gas dissolved in the cleaning liquid; and cleaning the semiconductor substrate by applying the cleaning liquid including bubbles of the gas to the surface of the semiconductor substrate.

According to a third aspect of the invention, there is provided a semiconductor substrate cleaning method comprising: mixing a liquid and a gas to form a flow of a cleaning liquid; mixing bubbles of the gas into the cleaning liquid; and cleaning the semiconductor substrate by applying the flowing cleaning liquid to the surface of the semiconductor substrate.

### BRIEF DESCRIPTION OF THE SEVERAL VIEWS OF THE DRAWING

FIG. 1 schematically shows the configuration of a semiconductor substrate cleaning apparatus according to a first embodiment of the invention;

FIG. 2 is a sectional view taken in a direction perpendicular to the sheet of paper of FIG. 1;

FIG. 3 is a characteristic diagram to help explain the relationship between the pH of an alkaline solution and a zeta potential;

FIG. 4 is a characteristic diagram to help explain the relationship between the pH of an acid solution and a zeta potential;

FIG. 5 is a sectional view to help explain another example of the semiconductor substrate cleaning apparatus according to the first embodiment;

FIG. 6 schematically shows the configuration of a semiconductor substrate cleaning apparatus according to a second embodiment of the invention;

FIG. 7 is a schematic configuration diagram to help explain another example of the semiconductor substrate cleaning apparatus according to the second embodiment;

FIG. 8A is an enlarged sectional view of a chemical spray nozzle to help explain a semiconductor substrate cleaning apparatus according to a third embodiment of the invention;

FIG. 8B is an enlarged sectional view of another configuration of the chemical spray nozzle to help explain the semiconductor substrate cleaning apparatus according to the third embodiment;

FIG. 9 is a process flow diagram to help explain the procedure for cleaning a semiconductor substrate in a sheet-feed cleaning apparatus;

FIG. 10 is a diagram showing the result of evaluating the particle removal rate according to the presence or absence of bubbles or chemical processing;

FIG. 11 schematically shows the configuration of an in-liquid bubble mixing apparatus according to a fourth embodiment of the invention; and

FIG. 12 schematically shows the configuration of a conventional bubble generator.

### DETAILED DESCRIPTION OF THE INVENTION

### First Embodiment

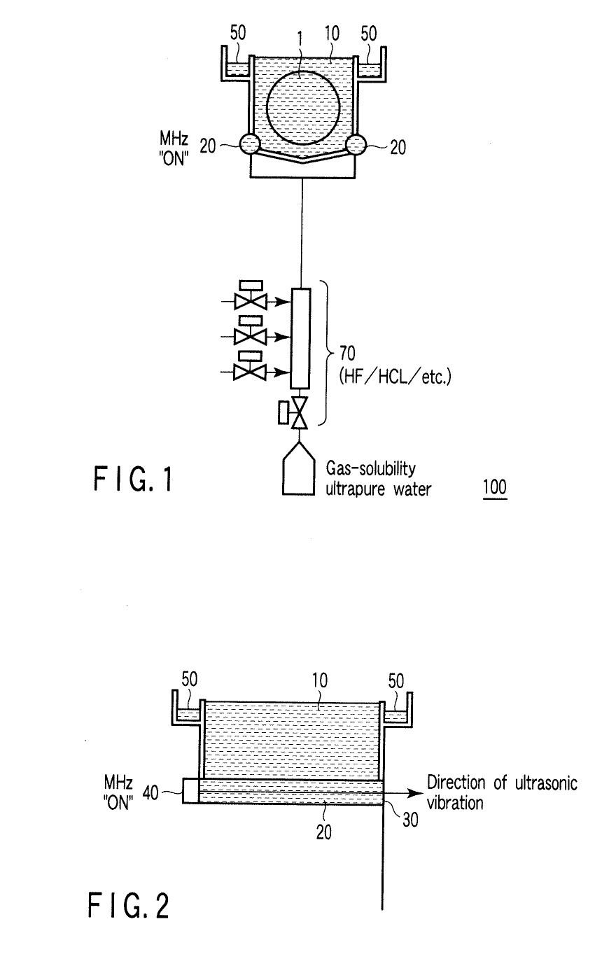

A semiconductor substrate cleaning method according to a first embodiment of the invention will be explained using FIGS. 1 to 5. In the first embodiment, ultrasonic waves are applied to a chemical in which gas is dissolved to a saturated concentration, thereby generating bubbles. Using a bubble/chemical mixed cleaning liquid, the semiconductor substrate is cleaned.

FIGS. 1 and 2 show a one-bath batch cleaning apparatus 100 as an example of a semiconductor substrate cleaning apparatus which carries out a semiconductor substrate cleaning method according to the first embodiment. FIG. 1 is a schematic configuration diagram and FIG. 2 is a sectional view taken in a direction perpendicular to the sheet of paper of FIG. 1.

As shown in FIGS. 1 and 2, a quartz processing bath 10 is filled with a chemical acting as a cleaning liquid. In the chemical, a wafer (semiconductor substrate) 1 is immersed. Chemical supply quartz tubes 20, which are for supplying the chemical to the quartz processing bath 10, are provided on both sides of the bottom of the quartz processing bath 10. Of both the ends of the chemical supply tube 20 in the longitudinal direction, one end is a chemical supply port 30 outside the processing bath. At the opposite end, an ultrasonic vibrator 40 is provided. A mixing valve 70 mixes gas-solubility ultrapure water (ultrapure water in which gas is dissolved to concentration of saturated solution), HF, HCL, and the like and supplies the resulting liquid to the chemical supply port 30.

The ultrasonic vibrator 40 is such that a vibrating plate is attached via a quartz plate to the opposite end of the chemical supply port 30. With this configuration, since vibration energy is radiated in the longitudinal direction of the chemical supply quartz tube 20, the wafer 1 in the processing bath 10 is not irradiated with vibrational waves. Thus, the chemical supplied from the chemical supply port 30 is caused to include bubbles using ultrasonic waves, thereby generating a chemical (bubbles/chemical mixed cleaning liquid) including bubbles of the nanometer or micrometer size. With this chemical cleaning liquid, the wafer 1 is cleaned. The chemical passed through the processing bath 10 in cleaning the wafer is discharged from a drain 50.

Although the wafer 1 of FIG. 1 is omitted in FIG. 2, a plurality of wafers are generally arranged in parallel in a direction perpendicular to the sheet of paper of FIG. 1. The number of wafers 1 may be one.

With the above configuration, the chemical supplied from the chemical supply quartz tube 20, that is, the cleaning liquid, may be either an alkaline solution or an acid solution.

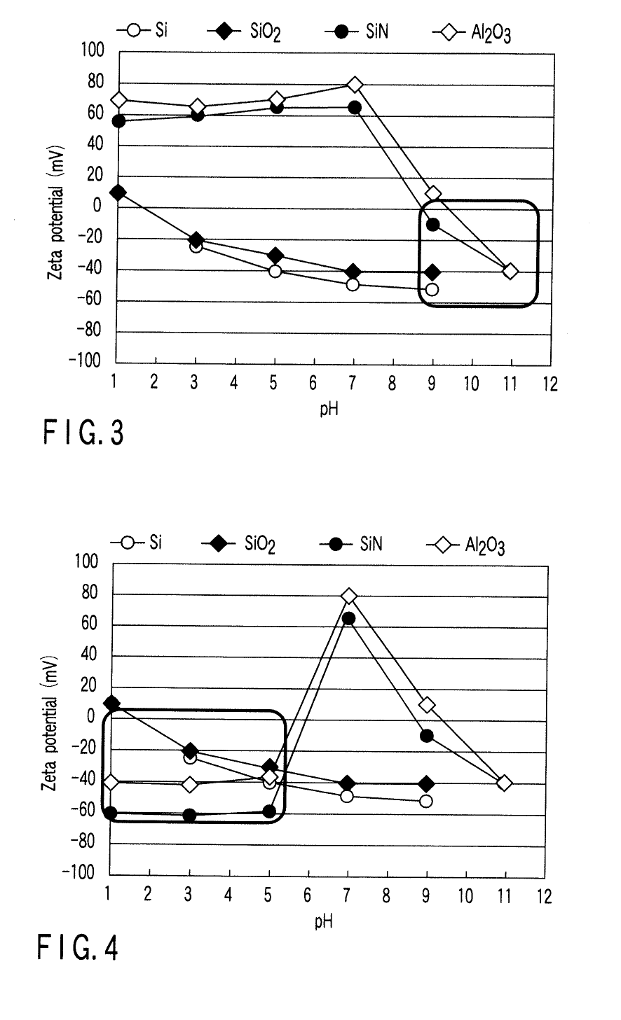

In the case of an alkaline solution, cleaning is done in an environment where the pH is 9 or more. In this case, the wafer 1 and particles (not shown) adsorbed to the wafer generally have minus zeta potentials as shown in FIG. 3 and are in a state where a repulsive force acts between the adsorbed particles and the semiconductor substrate. To increase the repulsive force by zeta potentials, it is desirable that the cleaning be performed in a strong alkaline environment.

In the case of an acid solution, using an interfacial active agent or the like, cleaning is done in a state where the zeta potentials of the wafer 1 and adsorbed particles are changed into the minus region. In this case, as the interfacial active agent (dispersing agent), for example, one or more chemical compounds having at least two sulfonic acid groups, a phytic acid compound, and a condensed phosphoric acid compound are used.

By using such interfacial active agents, the wafer 1 and adsorbed particles can be kept at a strongly-negative zeta potential state even in an acid solution, as shown in FIG. 4, as when an alkaline solution is used. However, to control the zeta potential, the dispersing agent added to the acid solution or alkaline solution is not limited to the above examples. Moreover, the cleaning liquid is not limited to the above example and another cleaning liquid may be used to increase the cleaning effect using bubbles, provided that a cleaning liquid capable of generating a repulsive force between the semiconductor substrate and the particles adsorbed to the semiconductor substrate is used.

To generate bubbles effectively when ultrasonic waves are applied to such a cleaning liquid as described below, a chemical in which gas has been dissolved so as to make the in-liquid dissolved gas concentration equal to the saturated concentration is used as the chemical introduced from the chemical supply port 30. For example, nitrogen (N₂) is used as the gas to be dissolved.

The ultrasonic vibrator 40 arranged at the bottom of the processing bath 10 is so provided that the direct advance wave of the ultrasonic vibration is not radiated directly to the wafer put in the processing bath 10 and is radiated to the supplied chemical itself. In other words, ultrasonic waves are applied so as not to cause pattern defects. That is, the wafer 1 is not placed in an environment where it receives vibrational waves. Therefore, the vertical component wave of the ultrasonic wave generated from the ultrasonic vibrator 40 is not radiated directly to the wafer 1.

As a result, both bubbles and cavities (reduced-pressure cavities) are formed in the chemical in the chemical supply tube 20. The cavity life is shorter than μsec and therefore the cavities do not reach the wafer 1. Unlike cavities, bubbles are gaseous foam and neither constrict nor collapse. Therefore, they can reach the wafer 1 in the processing bath 10.

It is said that cavities are formed when the frequency of the ultrasonic vibrator is below the frequency band ranging from several tens to several hundred of KHz. It is known that cavities are not formed in a frequency band higher than MHz. Accordingly, in the first embodiment, the ultrasonic vibrator attached to the chemical supply tube 20 is caused to operate at a frequency higher than 1 MHz. This makes it possible to generate in-liquid dissolved gas or nitrogen (N₂) bubbles of the nanometer or micrometer size effectively from the gas-saturated liquid almost without generating cavities.

In the first embodiment, the wafer 1 is not provided in the direct advance wave direction of the ultrasonic vibrator 40. From the viewpoint of both frequency and cavity life, it is clear that no cavitation takes place near the wafer 1.

As described above, the wafer 1 is cleaned using a bubble/chemical mixed cleaning liquid, further having the effect of cleaning, by bubbles, the adsorbed particles and the semiconductor substrate which both have negative zeta potentials and repel each other, which enables the adsorbed particles adhered to the micropatterns on the substrate to be cleaned and removed effectively. In this case, from the viewpoint of increasing the cleaning effect, it is desirable that the size of the bubbles be almost as large as the size of the micropatterns.

As described in the first embodiment, by cleaning the semiconductor substrate using a cleaning liquid including bubbles of the nanometer size or micrometer size almost as large as the size of the micropatterns, cleaning can be performed with an adsorbed particle removal rate higher than when cleaning is done using only a cleaning chemical without using bubbles.

That is, using a bubble/chemical mixed cleaning liquid including bubbles of the nanometer size or micrometer size makes it possible to apply a nano-size (or micro-size) physical force to microparticles making use of the coalition of bubbles near adsorbed particles at the wafer surface and a change in the volume of bubbles in the liquid occurring when adsorbed particles come into contact with bubbles.

In a conventional method of forming nano-bubbles by the electrolysis of water, since the liquid is neutral near a pH of 7, when the method is applied directly the cleaning of a semiconductor wafer, it is impossible to use the repulsive force produced by zeta potentials which separates the particles adsorbed to the wafer from the wafer. Accordingly, the effect of cleaning microparticles is considered to decrease.

However, in the first embodiment, since a cleaning liquid is so used that the zeta potential of the wafer and that of the adsorbed particles are both negative, an improvement in the cleaning effect can be expected.

Furthermore, if a conventional MHz cleaning method is applied directly to the wafer cleaning process in a microscopic semiconductor device manufacturing process, the longitudinal wave of the ultrasonic vibrator is radiated directly to the wafer. Cavities induced by ultrasonic waves near the wafer cause pattern defects. That is, since strong shock waves (cavitation) occur at the time of the constriction of cavities, this damages the micropatterns.

In the first embodiment, cleaning is done in a bubble/chemical mixed cleaning liquid using bubbles of differing cavities without generating cavities near the wafer. Accordingly, another bubble generating method may be used, provided that cavities are prevented from being generated near the wafer.

Even if cavities and bubbles are generated at the same time by means of ultrasonic waves, another method may be used, provided that the bubble generating method is such that shock waves caused by the collapse of cavities or the energy of ultrasonic vibration (longitudinal waves: in the direction of vibration) are not radiated to the wafer.

Furthermore, while nitrogen (N₂) has been used as the dissolved gas in the cleaning liquid, oxygen (O₂), purified air, or the like conventionally used in the semiconductor manufacturing processes may be used. That is, a gas which has been passed through a gas filter (with a Sieving diameter of 30 nm or less, more preferably 5 nm or less) for capturing particles (dust) mixed in the gas line may be used as bubbles.

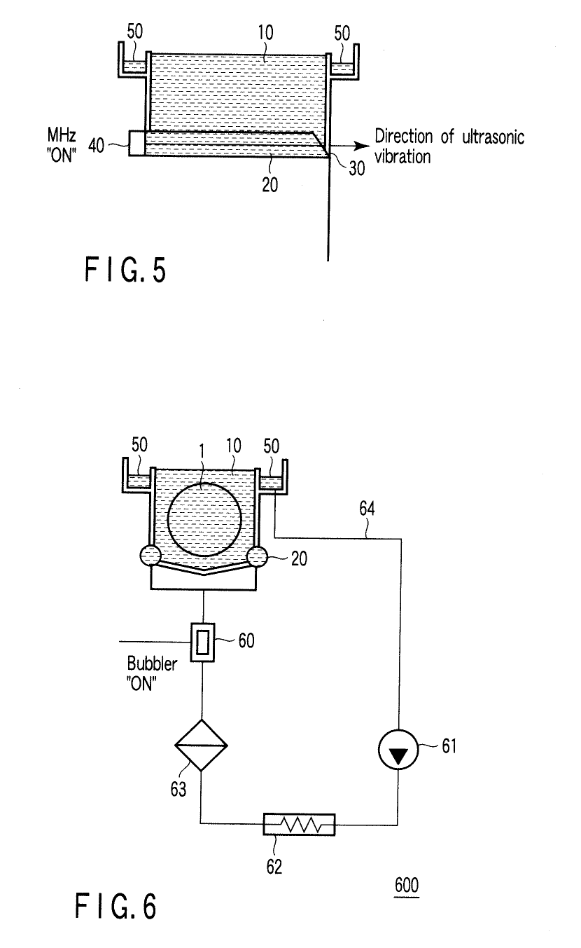

Still furthermore, it is more preferable to form the chemical supply port 30 into a shape having an inclination as shown in FIG. 5 so as to prevent reflected waves formed by the reflection of the ultrasonic vibration from going toward the wafer. With this configuration, the reflected wave can be prevented from retuning to the processing bath 10 (wafer 1), which enables damage to the device pattern to be reduced reliably.

### Second Embodiment

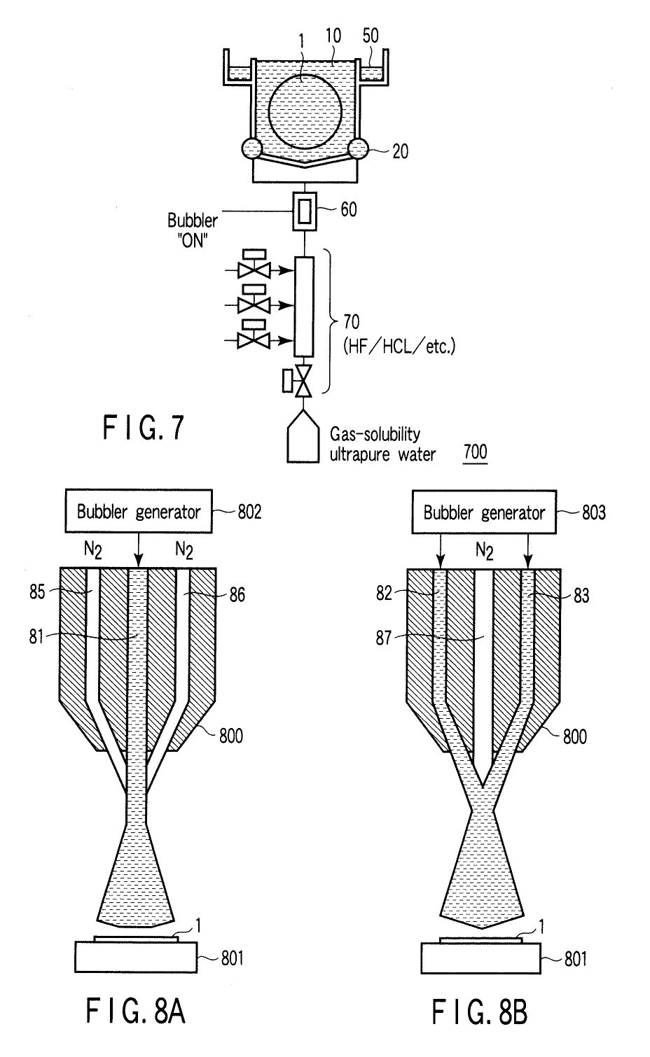

A semiconductor substrate cleaning method according to a second embodiment of the invention will be explained using FIGS. 6 and 7. In the second embodiment, using a bubbler (bubble generator), bubbles are generated in a chemical in which gas have been dissolved to the saturated concentration. Using a bubble/chemical mixed cleaning liquid, a semiconductor substrate is cleaned.

FIG. 6 shows a circulation batch cleaning apparatus 600 as an example of a semiconductor substrate cleaning apparatus which carries out a semiconductor substrate cleaning method according to the second embodiment. A chemical, which circulates through a circulation pipe 64, passes through a pump 61, a heater 62, and a filter 63. At a bubbler (bubble generator) 60, nitrogen (N₂) gas is mixed in the chemical, which is then supplied via a chemical supply quartz tube 20 to a quartz processing bath 10. After the cleaning liquid which cleaned a wafer 1 in the processing bath 10 overflows the processing bath 10 and is discharged to a drain 50, it passes through the pump 61, heater 62, and filter 63 again and is mixed with nitrogen (N₂) gas at the bubbler 60 and then supplied via the chemical supply quartz tube 20 to the quartz processing bath 10. The circulation of the cleaning liquid as described above is repeated.

In the second embodiment, too, a plurality of wafers are provided in parallel with a direction perpendicular to the sheet of paper of FIG. 6. The number of wafers 1 may be one.

Although the bubbler 60 is arranged behind a particle removal filter 63 provided in the circulation pipe 64 and in front of the processing bath 10 in FIG. 6, it may be arranged inside the processing bath 10. The reason why the bubbler 60 is arranged behind (on the secondary side of) the particle removal filter 63 is that, if the bubbler is arranged in front of (on the primary side of) the filter 63, bubbles escape into a primary air release line in the filter 63 and cannot be supplied effectively to the processing bath 10 in which the wafer 1 is set.

In the second embodiment, an ejector is used as the bubbler 60. In the ejector 60, nitrogen (N₂) gas is sucked into the circulating chemical. At that time, bubbles of the nanometer size or micrometer size are generated. Although the size and density of bubbles generated are influenced by the difference in the viscosity of the circulating chemical, this can be coped with by the optimization of the cleaning condition. In the chemical passed through the ejector 60, nitrogen (N₂) gas has been dissolved to the saturated concentration.

As in the first embodiment, two types of solution, an alkaline solution and acid solution, can be considered as the chemical (cleaning liquid) used in the second embodiment.

In the case of an alkaline solution, cleaning is done in an environment where the pH is 9 or more. In the case of an acid solution, using as an interfacial active agent, for example, one or more chemical compounds having at least two sulfonic acid groups in one molecule, a phytic acid compound, and a condensed phosphoric acid compound, the wafer is cleaned in a state where the zeta potentials of the wafer 1 and adsorbed particles are changed into the negative region.

In a method using the ejector, since the amount of gas is determined by the flow velocity of the liquid, the ejector has to be matched with the component parts of the circulating system excluding the ejector, including the diameter of the circulation pipe 64 and the capability of the circulating pump 61. In the second embodiment, for example, the diameter of the pipe 64 is 1 inch and the capability of the pump 61 is 30 (L/min). However, it goes without saying that they may be modified suitably according to the situation.

In the second embodiment, too, oxygen (O₂), purified air, or the like conventionally used in the semiconductor manufacturing processes may be used as the dissolved gas in the cleaning liquid. That is, gas which has been passed through a gas filter (with a Sieving diameter of 30 nm or less, more preferably 5 nm or less) for capturing particles (dust) mixed in the gas line may be used as bubbles.

To suppress the separation of the bubbles and the chemical as much as possible after the ejector 60 mixes the gas into the cleaning liquid, it is desirable that the plumbing distance from the ejector 60 to the processing bath 10 be shorter. Moreover, while in FIG. 6, only one ejector has been used, ejectors may be connected directly to the chemical supply tubes 20 on both sides of the processing bath 10. In that case, there are provided as many ejectors as the number of chemical supply tubes.

Furthermore, using the ejector as the bubbler can miniaturize the size of bubbles further than in a conventional bubble generating method using a quartz ball bubbler provided at the bottom of the processing bath. When a quartz ball bubbler is used, large bubbles are formed at the top surface of the liquid in the processing bath. However, when bubbles are formed by the ejector, an enormous number of micro-bubbles are formed at the top surface of the liquid in the processing bath, which has been verified by test.

It is known that the size of bubbles generally becomes larger as time passes because a plurality of bubbles coalesce with one another. However, bubbles of the nanometer or micrometer size are formed in the bubble forming stage, which enables the bubbles to keep the microscopic size even if they have reached the top surface of the liquid in the processing bath.

The effect of removing particles adsorbed to the semiconductor wafer by cleaning with a chemical including bubbles depends strongly on the size and density of bubbles in the liquid. Since bubbles of the millimeter size are formed with a conventional quartz bubbler, the micropatterns of the nanometer or micrometer size on the semiconductor wafer do not come into contact with particles of the same size. Consequently, the conventional bubbler has no particle removing capability, whereas the second embodiment can achieve the capability.

The cleaning effect depends strongly on the bubble density in a liquid. As the bubble density increases, the cleaning effect increases. When the bubble density is measured, a state where the bubble density is several million bubbles/ml or more is favorable for cleaning.

While in the second embodiment, the ejector has been used as the bubbler, another method of dissolving gas until the supersaturated state is reached and then the gas is introduced via a gas/liquid separation filter (membrane filter) may be applied. The gas to be introduced is dissolved to the saturated state once and then the gas is introduced via the filter, which enables a desired quantity of bubbles to be generated with a good controllability.

The reason why the liquid in which gas has been dissolved to the saturated state once is used is that it is known that, if the gas has not been dissolved to the saturated state, the gas dissolves in the liquid and defoams at the same time when the gas is introduced through the filter in the form of bubbles and bubbles cannot be generated with a good controllability.

While in the second embodiment, the circulation batch cleaning apparatus 600 of FIG. 6 has been explained, a one-bath batch cleaning apparatus 700 provided with an ejector 60 as shown in FIG. 7 may be used to generate bubbles in a cleaning liquid, thereby producing the same effect as described above.

In FIG. 7, the ejector 60 acting as a bubble generator is provided behind a chemical mixing valve 70 for introducing a chemical and in front of (the primary side of) the processing bath 10. In this case, too, it is desirable that the plumbing distance from the ejector 60 to the processing bath 10 be shorter. Therefore, the ejector may be connected directly to the inside of the processing bath 10 or to the chemical supply tubes 20 on both sides of the processing bath 10.

As described in the first embodiment, by cleaning the semiconductor substrate using a cleaning liquid including bubbles, cleaning can be performed at an adsorbed particle removal efficiency higher than when cleaning is done using only a cleaning chemical without using bubbles.

In the second embodiment, a bubble/chemical mixed cleaning liquid including bubbles of the nanometer size or micrometer size larger than the size of the micropatterns is used for cleaning a wafer. This makes it possible to apply a nano-size (or micro-size) physical force to microparticles making use of the coalition of bubbles near adsorbed particles at the wafer surface and a change in the volume of bubbles in the liquid occurring when adsorbed particles come into contact with bubbles.

### Third Embodiment

Next, a semiconductor substrate cleaning method according to a third embodiment of the invention will be explained using FIGS. 8A and 8B. In the third embodiment, a semiconductor substrate is cleaned using a bubble-mixed liquid in a two-fluid jet cleaning method using two fluids, liquid and gas.

In a rotary drying technique using a sheet-feed cleaning apparatus, a method of supplying a cleaning liquid to a rotating wafer in such a manner that the liquid is sprayed to the center of the wafer and a method of supplying a cleaning liquid to the wafer from a scan nozzle can be used. Both methods are generally used in a sheet-feed cleaning apparatus.

The third embodiment is characterized by a method of supplying a chemical. Specifically, as shown in FIG. 8A, a bubble generator 802 is provided on the chemical flow (or purified water flow) 81 supplying side of a jet nozzle (chemical spray nozzle) 800. When a chemical is sprayed from the jet nozzle 800, the chemical flow (or purified water flow) 81 is mixed in such a manner that the flow 81 is sheared by gas flows 85, 86 made of, for example, nitrogen (N₂) and, at the same time, the bubble generator 802 mixes bubbles into the chemical flow 81. Bubbles are of the nanometer or micrometer size. More preferably, the minimum particle diameter is 50 nm or less. The cleaning liquid produced this way is supplied to the rotating wafer 1 on the rotary drying sheet-feed cleaning apparatus 801, thereby cleaning the wafer.

As shown in FIG. 8B, a bubble generator 803 may be provided on the chemical flow 82, 83 supplying side of the jet nozzle 800. When a chemical is sprayed from the jet nozzle 800, the chemical flows 82, 83 are mixed in such a manner that the flows are sheared by a gas flow 87 made of, for example, nitrogen (N₂) and, at the same time, the bubble generator 803 mixes bubbles into the chemical flows 82, 83. Bubbles are of the nanometer or micrometer size. More preferably, the minimum particle diameter is 50 nm or less. The cleaning liquid produced this way is supplied to the rotating wafer 1 on the rotary drying sheet-feed cleaning apparatus 801, thereby cleaning the wafer.

In a conventional two-fluid cleaning method using purified water (deionized water) without bubbles as a liquid, the liquid was only sheared by gas (N₂ knife) and therefore only balls of purified water were formed. In the third embodiment, however, since a liquid in which bubbles of the nanometer or micrometer size larger than the size of micropatterns have been mixed is used, the chemical sprayed from the jet nozzle 800 is turned into smaller droplets than in the conventional method. Moreover, bubbles are mixed in the smaller droplets and therefore the size of the bubbles also becomes smaller.

In addition to the conventional cleaning effect using droplets, the third embodiment can prevent removed dust from adsorbing to the wafer 1 again and discharge it outside the wafer by making use of the surface energy of bubbles.

The third embodiment, of course, has the aforementioned effect even if purified water is used in place of the chemical. In the case of a chemical, using either an alkaline solution or an acid solution explained in detail in the first embodiment makes it possible to increase the cleaning effect as in the first and second embodiments.

Furthermore, the third embodiment uses a liquid which is obtained by adding chemicals to extra-pure water and in which nitrogen (N₂), oxygen (O₂), purified air or another kind of gas is dissolved so that in-liquid dissolved gas concentration may be the saturated concentration. The liquid should be preferably kept in the state where bubbles of the same gas are present in the supersaturated liquid without being dissolved again, as in the first and second embodiments.

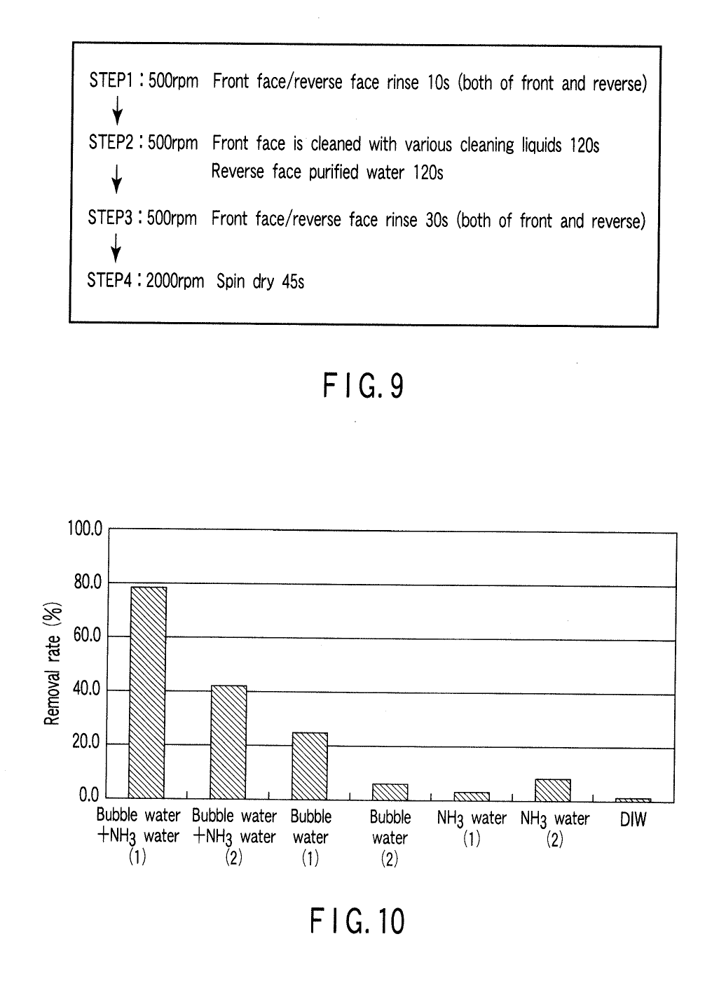

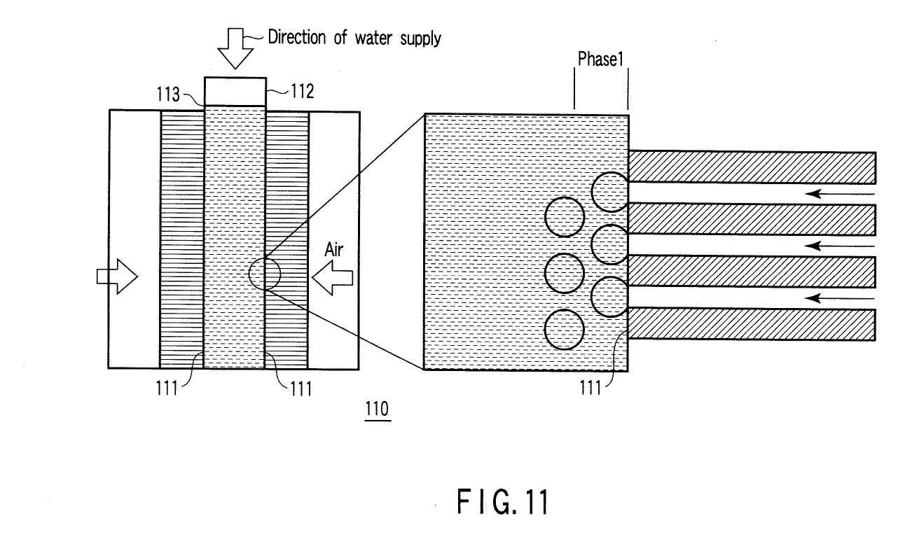

FIG. 10 shows the result of evaluating the particle removal rate depending on whether or not bubbles are present or whether or not chemical processing is present (or whether NH₃ solution or deionized water is used) when cleaning is done following the cleaning procedure as shown in FIG. 9. In FIGS. 10, (1) and (2) show different trial results.

As seen from FIG. 10, the removal rate is 20% or less in a bubble-free cleaning method. However, under the condition where bubbles are present (bubble-mixed water is used), the particle removal rate is improved. The removal rate fluctuates according to the particle adsorbing condition, chemical processing condition, processing time, and the like. Accordingly, the condition has to be examined for each step of each device process.

### Fourth Embodiment

An in-liquid bubble mixing apparatus according to a fourth embodiment of the invention will be explained using FIG. 11.

The in-liquid bubble mixing apparatus of the fourth embodiment can stably generate bubbles of the nanometer and micrometer sizes almost as large as the size of micropatterns on a substrate. The in-liquid bubble mixing apparatus is as follows. First, a force other than buoyancy is applied to bubbles at a bubble generating region. Alternatively, a force higher than the shear force caused by the liquid current is applied to bubbles. Moreover, after bubbles are generated in the liquid, gas used for bubbles is dissolved in the liquid to oversaturation in advance to suppress the self-collapse of bubbles (the dissolution of bubbles into the liquid).

In the in-liquid bubble mixing apparatus 110 of the fourth embodiment shown in FIG. 11, gas is supplied from capillary tubes to a capillary tube wall 111 (gas intake part). A chemical flows downward from a liquid inflow part 113 above the sheet of paper in the center of the in-liquid bubble mixing apparatus 110. There is provided an ultrasonic vibrator 112 (ultrasonic wave generating part) having a vibrating surface perpendicular to the direction in which the liquid flows. With this configuration, the ultrasonic vibrator 112 supplies vibration energy caused by MHz direct advance waves to the interface region between the capillary tube wall 111 and the liquid.

This makes it possible to apply ultrasonic waves in a direction parallel to the liquid current and perpendicular to the direction in which the capillary tube wall 111 generates bubbles. In other words, the capillary tube wall 111 injects gas into an ultrasonic wave applying region in the liquid.

As a result, since a shear force stronger than the shear force caused by the liquid current can be applied to the bubbles generated from the capillary tube wall 111, nanometer-sized bubbles before the growth dissociate easily from the wall (or detach easily from the capillary tube). That is, bubbles can separate from the capillary tube wall 111 in the Phase 1 region of the right enlarged view of FIG. 11. This makes it possible to mix nanometer-sized bubbles into the liquid. The size of bubbles obtained from the in-liquid bubble mixing apparatus 110 has a particle diameter distribution of several tens to several hundreds of nanometers.

Furthermore, to cause ultrasonic waves to generate bubbles effectively, a chemical or purified water in which gas has been dissolved until the in-liquid dissolved gas concentration has reached to the saturated concentration is selected as a liquid to be introduced. For example, a chemical based on nitrogen (N₂)-dissolved purified water may be used.

As described above, when a liquid in which a gas has been dissolved to the saturated concentration is used, bubbles detached from the capillary tube wall 111 can hold the bubble structure stably without dissolving in the liquid. Therefore, a gas dissolving apparatus which dissolves the gas introduced from the capillary tube wall 111 to the in-liquid bubble mixing apparatus 110 into the liquid caused to flow from the liquid inflow part 113 almost to the saturated solubility may be provided in front of the liquid inflow part 113, for example, in the upper stage of the in-liquid bubble mixing apparatus 111 of FIG. 11.

Although nitrogen (N₂) has been used here, oxygen (O₂), purified air, or the like conventionally used in the semiconductor manufacturing processes may be used. That is, a gas which has been passed through a gas filter (with a Sieving diameter of 30 nm or less, more preferably 5 nm or less) for capturing particles (dust) mixed in the gas line may be used as bubbles.

Moreover, as in the first to third embodiments, when a chemical is used as a liquid, two types of solution, an alkaline solution and acid solution, may be applied as the chemical. In a conventional bubble generator as shown in

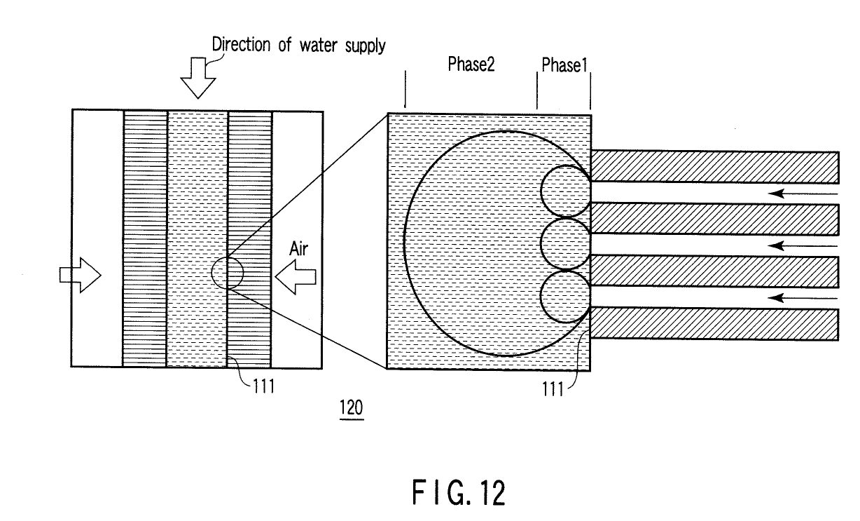

FIG. 12, when the adherence of bubbles to the capillary tube wall 111 is stronger than the buoyancy of bubbles, the bubbles grow bigger without detaching from the capillary tube wall 111. That is, in a region closer to the capillary tube wall 111 (Phase 1 region in the right enlarged view of FIG. 12), there is almost no flow of liquid and the liquid is only supplied to the capillary tube wall 111 by diffusion. Since a shear energy due to the liquid current is not supplied to the interface region, the bubbles cannot detach in the form of small bubbles and therefore expand naturally.

Thus, only after the bubbles at the tip of the capillary tube combine to form larger-sized bubbles (reaching Phase 2 region in the right enlarged view of FIG. 12), when the resistance caused by the liquid current has exerted a shear force (shear energy) stronger than a certain level on the bubbles, the bubbles start to detach from the capillary tube wall 111. As described above, when bubbles are generated by the conventional method, the bubble size becomes about several hundred micrometers (μm).

In contrast, with the in-liquid bubble mixing apparatus according to the fourth embodiment, gas is injected from the gas intake part into the ultrasonic wave applying region in the liquid, thereby enabling bubbles made of the gas to be mixed in the liquid efficiently. That is, bubbles of the nanometer and micrometer sizes almost as large as the size of micropatterns on the substrate can be generated stably.

Accordingly, the in-liquid bubble mixing apparatus of the fourth embodiment can be used in place of the bubbler (ejector) used in the second embodiment (of FIGS. 6 and 7) or used as the bubble generator which supplies the chemical flows (or purified water flows) 81, 82, 83 to the jet nozzle 800 of FIG. 8 explained in the third embodiment. This enables the third embodiment to stably generate bubbles of the nanometer and micrometer sizes almost as large as the size of micropatterns on the substrate.

As described above, in a semiconductor substrate cleaning method according to an embodiment of the invention, the semiconductor substrate is cleaned using a cleaning liquid obtained by mixing the gas bubbles into any one of an acid solution, in which a gas has been dissolved to the saturated concentration and which brings the zeta potentials of the semiconductor substrate and adsorbed particles into the negative region by the introduction of an interfacial active agent, or an alkaline solution, in which gas has been dissolved to the saturated concentration and whose pH is 9 or more.

Therefore, when an acid solution is used as the liquid, one or more chemical compounds having at least two sulfonic acid groups in one molecule, a phytic acid compound, and a condensed phosphoric acid compound is used as the interfacial active agent.

Moreover, a semiconductor substrate cleaning method according to an embodiment of the invention is a two-fluid cleaning method of forming a flow of a cleaning liquid by mixing a fluid and gas and cleaning a semiconductor substrate using the flow of the cleaning liquid. In the method, a bubble-mixed liquid is used.

Furthermore, an in-liquid bubble mixing apparatus according to an embodiment of the invention comprises a liquid inflow part which causes a liquid to flow in, an ultrasonic wave generating part which generates ultrasonic waves in the liquid, and a gas intake part which introduces gas into the liquid, wherein the gas is injected from the gas intake part into an ultrasonic wave applying region in the liquid, thereby mixing bubbles into the liquid.

Furthermore, a semiconductor substrate cleaning apparatus according to an embodiment of the invention comprises a processing bath for cleaning a semiconductor substrate using a cleaning liquid, and a cleaning liquid producing unit which produces the cleaning liquid by mixing bubbles of a gas into any one of an acid solution, in which the gas has been dissolved to a saturated concentration and which brings the zeta potentials of the semiconductor substrate and adsorbed particles into a negative region by the introduction of an interfacial active agent, or an alkaline solution, in which the gas has been dissolved to a saturated concentration and whose pH is 9 or more.

As described above, according to an aspect of the invention, there is provided a semiconductor substrate cleaning method capable of effectively removing microparticles adsorbed to the surface of the semiconductor substrate. Moreover, it is possible to provide a semiconductor substrate cleaning apparatus using the cleaning method and an in-liquid bubble mixing apparatus used in the method and apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1.-14. (canceled)

15. A semiconductor substrate cleaning method comprising:
mixing a liquid and a gas to form a flow of a cleaning liquid;
mixing bubbles of the gas into the cleaning liquid; and
cleaning the semiconductor substrate by applying the flowing cleaning liquid to the surface of the semiconductor substrate.

16. The semiconductor substrate cleaning method according to claim 15, wherein mixing bubbles of the gas into the cleaning liquid includes mixing bubbles into the cleaning liquid by injecting the gas from a gas intake part into an ultrasonic wave applying region.

17. The semiconductor substrate cleaning method according to claim 15, wherein the gas intake part is a capillary tube wall to which a gas is supplied from a capillary tube and which injects the gas into the ultrasonic wave applying region in the cleaning liquid.

18. The semiconductor substrate cleaning method according to claim 15, wherein mixing bubbles of the gas into the cleaning liquid includes mixing bubbles of the gas by supplying bubbles from a bubble generator provided on the chemical supplying side of a chemical spray nozzle.

19. The semiconductor substrate cleaning method according to claim 18, wherein the bubble generator includes an ultrasonic vibrator which applies ultrasonic waves in a direction perpendicular to the direction in which the cleaning liquid flows and which vibrates the cleaning liquid ultrasonically to generate bubbles.

20. The semiconductor substrate cleaning method according to claim 15, wherein the size of the bubbles is practically equal to the size of patterns formed at the surface of the semiconductor substrate.
